(19) United States
(12) Patent Application Publication
(10) Pub. No.: US 2009/0170498 A1
(43) Pub. Date: Jul. 2, 2009

(54) METHOD AND APPARATUS FOR EXPEDITED CELL RESELECTION DURING ACCESS PROCEDURES FOR CELLULAR MOBILE STATIONS

(75) Inventors: Ramasamy VENKATASUBRAMANIAN, Chicago, IL (US); Charles Binzel, Bristol, WI (US); Daniel Chisu, Bristol, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/967,512

(22) Filed: Dec. 31, 2007

(51) Int. Cl. H04Q 7/20

(52) U.S. Cl. 455/422.1

(57) ABSTRACT

A method, apparatus, and electronic device for establishing a cellular connection are disclosed. A processor 104 may select a primary telecommunication cell. A primary radio 212 may decode a primary connection parameter for the primary telecommunication cell. The primary radio 212 may execute an initial primary connection attempt with the primary telecommunication cell. The primary radio 212 or a secondary radio 214 may decode a secondary connection parameter for a secondary telecommunication cell prior to a subsequent primary connection attempt.

### FIELD OF THE INVENTION

The present invention relates to a method and system for establishing a cellular connection. The present invention further relates to cell reselection.

### INTRODUCTION

A mobile client device may connect with a network in order to allow access to a variety of services and data. During an access procedure, such as a call setup, the mobile client device may send a message along a random access channel (RACH) to a selected cell of a network. The mobile client device may wait for an immediate assignment. If the client mobile device fails to obtain an assignment from that cell, the mobile client device may try to connect to a second cell once the attempts on the first cell has timed out.

### SUMMARY OF THE INVENTION

A method, apparatus, and electronic device for establishing a cellular connection are disclosed. A processor may select a primary telecommunication cell. A primary radio may decode a primary connection parameter for the primary telecommunication cell. The primary radio may execute an initial primary connection attempt with the primary telecommunication cell. The primary radio or a secondary radio may decode a secondary connection parameter for a secondary telecommunication cell prior to a subsequent primary connection attempt.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a handheld device that may be used to implement the communication protocol management method.

FIG. 2 illustrates in a block diagram one embodiment of a cellular telephone systems.

FIG. 3 illustrates in flowchart a previous embodiment of a cell reselection method.

FIGS. 4a-b shows in timing diagrams decoding procedures.

FIG. 5 illustrates in a block diagram one embodiment of a standard time window.

FIG. 6 illustrates in a flowchart one embodiment for a method of executing an expedited call set up.

FIG. 7 illustrates in a flowchart one embodiment of an expedited cell reselect process.

FIG. 8 illustrates in a flowchart one embodiment of a method of adjusting the access process to reflect channel quality.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for establishing a cellular connection are disclosed. A mobile client device (MCD) may speed up the cellular access process by decoding the connection parameters for a secondary, or backup, telecommunication cell during the access process with the primary telecommunication cell. The MCD may make use of a latency time following a connection attempt and before a response to decode the secondary connection parameters. The MCD may further make use of downtime during the response decoding process to further decode the secondary connection parameters. Thus, when the MCD has made a threshold number of access attempts, the MCD may reselect the secondary communications cell more quickly. The MCD may adjust the threshold number of access attempts based on a channel quality between the MCD and the primary telecommunications cell.

A processor may select a primary telecommunication cell. A primary radio may decode a primary connection parameter for the primary telecommunication cell. The primary radio may execute an initial primary connection attempt with the primary telecommunication cell. The primary radio or a secondary radio may decode a secondary connection parameter for a secondary telecommunication cell prior to a subsequent primary connection attempt.

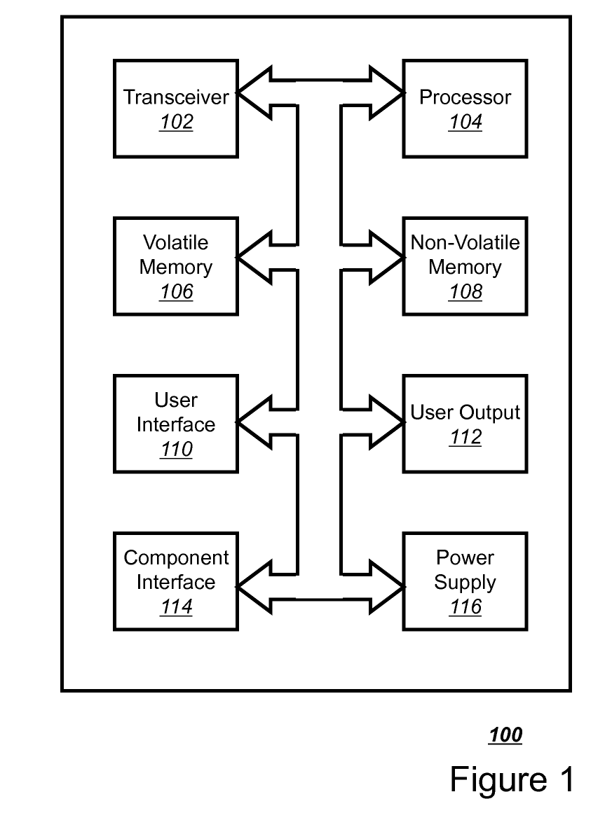

FIG. 1 illustrates in a block diagram one embodiment of a handheld device 100 that may be used as a MCD. While a handheld device is described, any computing device with wireless capability may implement this cellular method. The handheld device 100 may exchange information or data with a network. The handheld device 100 may support one or more applications for performing various communications with the network. The handheld device 100 may implement any operating system, such as Windows or UNIX, for example. Client and server software may be written in any programming language, such as C, C++, Java or Visual Basic, for example. The handheld device 100 may be a mobile phone, a laptop, a personal digital assistant (PDA), or other portable device. For some embodiments of the present invention, the handheld device 100 may be a WiFi capable device, which may be used to access the network for data or by voice using voice over internet protocol (VOIP). The handheld device 100 may include a transceiver 102 to send and receive data over the network.

The handheld device 100 may include a controller or processor 104 that executes stored programs. The controller or processor 104 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The handheld device 100 may also include a volatile memory 106 and a non-volatile memory 108 to be used by the processor 104. The volatile 106 and nonvolatile data storage 108 may include one or more electrical, magnetic or optical memories such as a random access memory (RAM, cache, hard drive, or other memory device. The memory may have a cache to speed access to specific data. The memory may also be connected to a compact disc-read only memory (CD-ROM), digital video disc-read only memory (DVD-ROM, DVD read write input, tape drive or other removable memory device that allows media content to be directly uploaded into the system.

The handheld device 100 may include a user input interface 110 that may comprise elements such as a keypad, display, touch screen, or any other device that accepts input. The handheld device 100 may also include a user output device that may comprise a display screen and an audio interface 112 that may comprise elements such as a microphone, earphone, and speaker. The handheld device 100 also may include a component interface 114 to which additional elements may be attached, for example, a universal serial bus (USB) interface or an audio-video capture mechanism. Finally, the handheld device 100 may include a power supply 116.

Client software and databases may be accessed by the controller or processor 104 from the memory, and may include, for example, database applications, word processing applications, video processing applications as well as components that embody the decision support functionality of the present invention. The user access data may be stored in either a database accessible through a database interface or in the memory. The handheld device 100 may implement any operating system, such as Windows or UNIX, for example. Client and server software may be written in any programming language, such as ABAP, C, C++, Java or Visual Basic, for example.

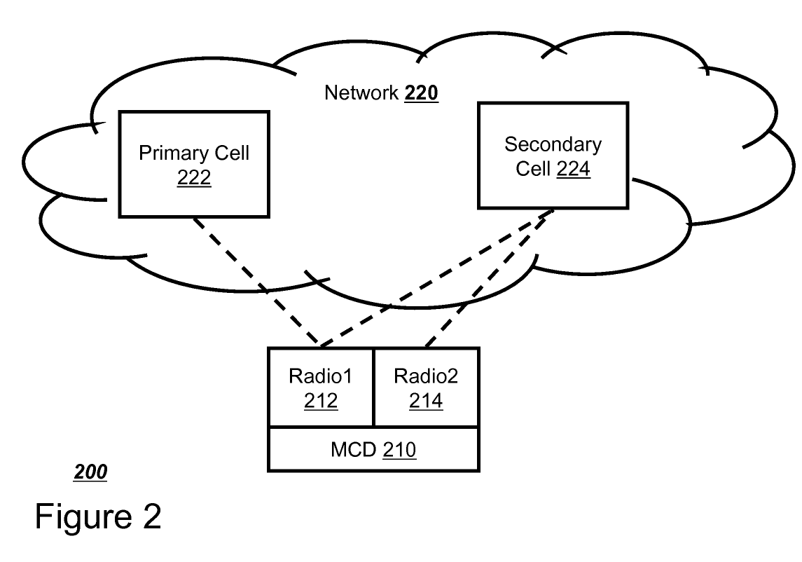

A MCD may access a network and maintain a connection with that network using a series of telecommunications cells. FIG. 2 illustrates in a block diagram one embodiment of a cellular telephone system 200. The MCD 210 may seek to access a network 220. The MCD 210 may have a transceiver 102 with a single radio 212. Alternatively, the transceiver 102 of the MCD 210 may have a second radio 214. The MCD 210 may seek to create a connection with the network 220 by accessing a primary telecommunications cell (PTC) 222, also called a base transceiver station BTS), with the first radio 212. The MCD 210 may download system information (SI), or primary connection parameters, about the PTC 222 over the cell's broadcast channel (BCH). The BCH may include a broadcast control channel (BCCH) to access and identify the network, a synchronization channel (SCH) to identify and synchronize with the PTC 222, and a frequency correction channel (FCCH) to establish the cell carrier frequency and enable corrections. The MCD 210 may make an initial primary connection attempt by making an access request with the PTC 222 on the random access channel (RACH). The PTC 222 may grant network access to the MCD 210 by sending an immediate assignment (IA) message on the access grant channel (AGCH).

Previously, after the PTC 222 failed to grant access after a threshold number of primary connection attempts was reached, the MCD 210 would download the SI for the secondary telecommunication cell (STC) 224. The terms “primary telecommunication cell” and “secondary telecommunication cell” are merely used to distinguish between first and second cells chosen, and do not bestow any type of status upon those cells. The MCD 210 would then attempt a secondary connection attempt.

Under the present invention, after the initial primary connection attempt and prior to a subsequent primary connection attempt, the MCD 210 may download the secondary connection parameters for the STC 224, in preparation for a secondary connection attempt. The MCD 210 may use the first radio 212 or the second radio 214 to download the secondary connection parameters.

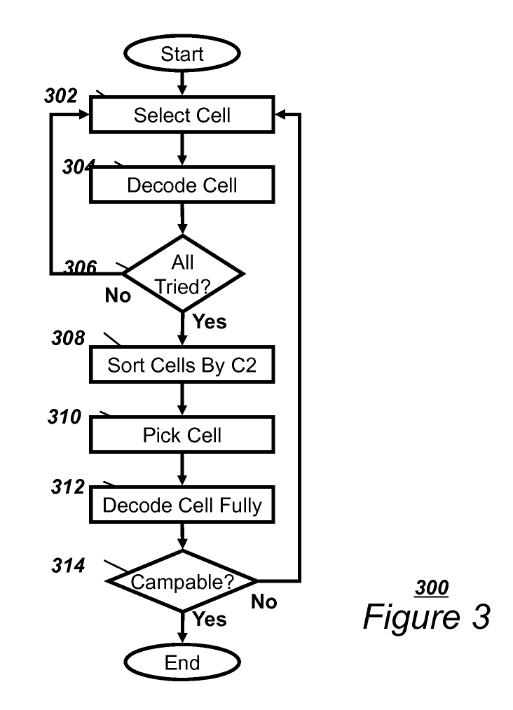

Previous attempts to access a cellular network required the MCD to wait until the connection attempts with the primary telecommunications cell had failed. FIG. 3 illustrates in flowchart a previous embodiment of a cell reselection method 300. Upon the failure of the primary connection attempt, the MCD 210 may pick a cell from a list of secondary cells (Block 302). The MCD 210 may partially decode the cell SI using the FCH, SCH, and BCCH (Block 304). The MCD 210 may repeat the partial decoding for every cell on the list (Block 306). The MCD 210 may sort all the cells on the list by using cell reselection criteria (C2). The MCD 210 may pick a cell from the list (Block 308). The MCD 210 may fully decode the selected cell (Block 310). If the MCD 210 is unable to camp on that cell (Block 312), the MCD 210 repeats the process from the beginning (Block 302).

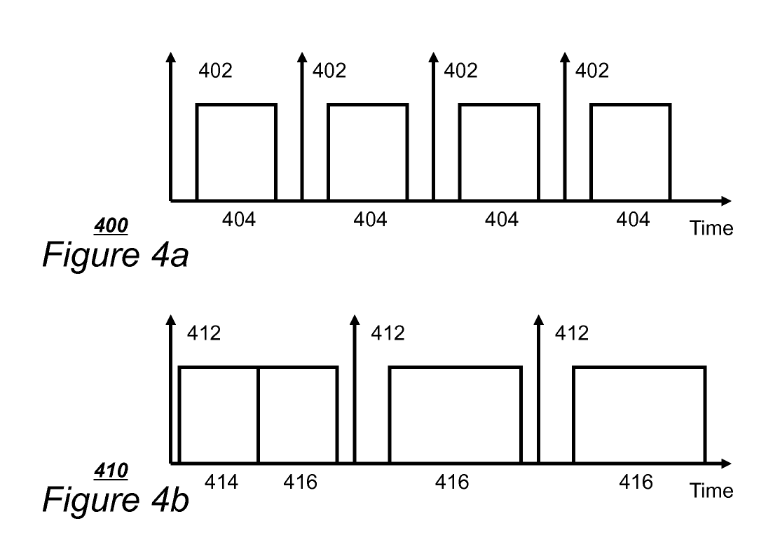

FIG. 4a shows in a timing diagram a previous embodiment of the decoding procedure 400. The MCD 210 may send an initial RACH message 402. Before sending a subsequent RACH message 402, the MCD 210 may decode the serving cell BCCH for an assignment during time period 404. Via the BCCH, the network 220 may set the amount of time before resending a RACH message and the maximum number of RACH messages to be sent.

The network response latency between the first RACH message sent by the MCD 210 and the first IA response tends to be 100 ms. The MCD 210 may use this network response latency to begin decoding the connection parameters for a secondary telecommunications cell. FIG. 4b shows in a timing diagram one embodiment of the decoding procedure 410 under the current invention. The MCD 210 may send an initial RACH message 412. Prior to the time to send a subsequent RACH message 412, the MCD 210 may decode the SI for a neighboring cell or go into deep sleep mode 414. Then, the MCD 210 may decode the serving cell BCCH for an assignment or the neighbor cell BCCH during time period 416.

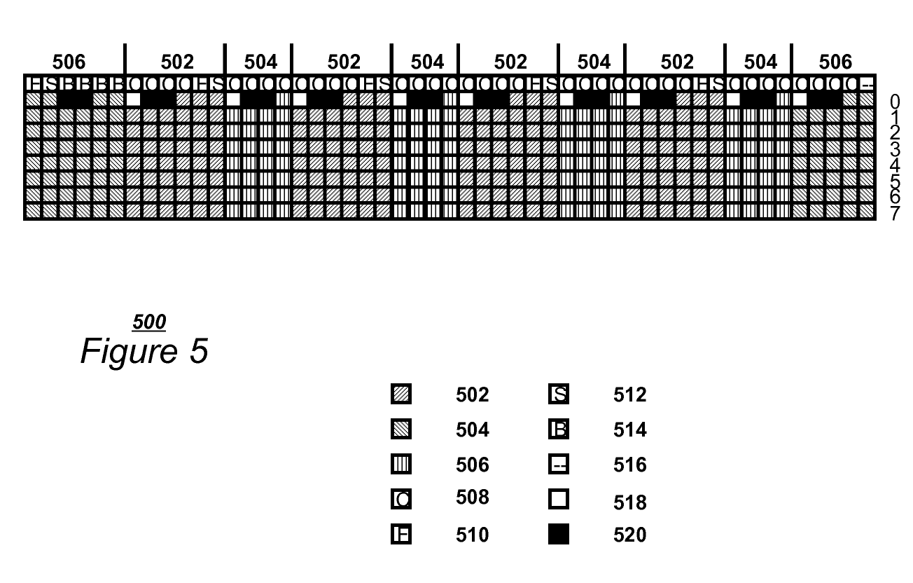

The MCD 210 may also make use of downtime present during the decoding of an IA response. FIG. 5 illustrates in a block diagram one embodiment of a standard time window 500, which repeats multiple times during the decoding period 416. A fifty-one frame window may have eight slots each using a time division multiple access (TDMA) method. More than 90% of the unused slots, equating to 220 ms, may be used for decoding a neighboring cell on the BCCH. Each window may have multiple instances of a first time window (T1) 502, a second time window (T2) 504, and a third time window (T3) 506. Each T1 instance 502 may have four frames for the common control channel (CCH) 508, one frame for the FCH 510, and one frame for the SCH 512. Each T2 instance 504 may have four frames for the CCH 508. Each T3 instance 506 may have a frame for the FCH 510, a frame for the SCH 512, four frames for the BCCH 514, four frames for the CCH 508, and an idle frame 516. One slot in each time window instance, except the first T3 instance, may be an active slot 518. A few of the slots may be ambiguous slots 520, being available or not. The MCD 210 may decode the BCCH of a neighboring cell during any available, or inactive, frame. A standard time window 500 may have four hundred eight TDMA frames, with anywhere from 379 to 399 TDMA frames available to decode the BCCH of a neighboring cell.

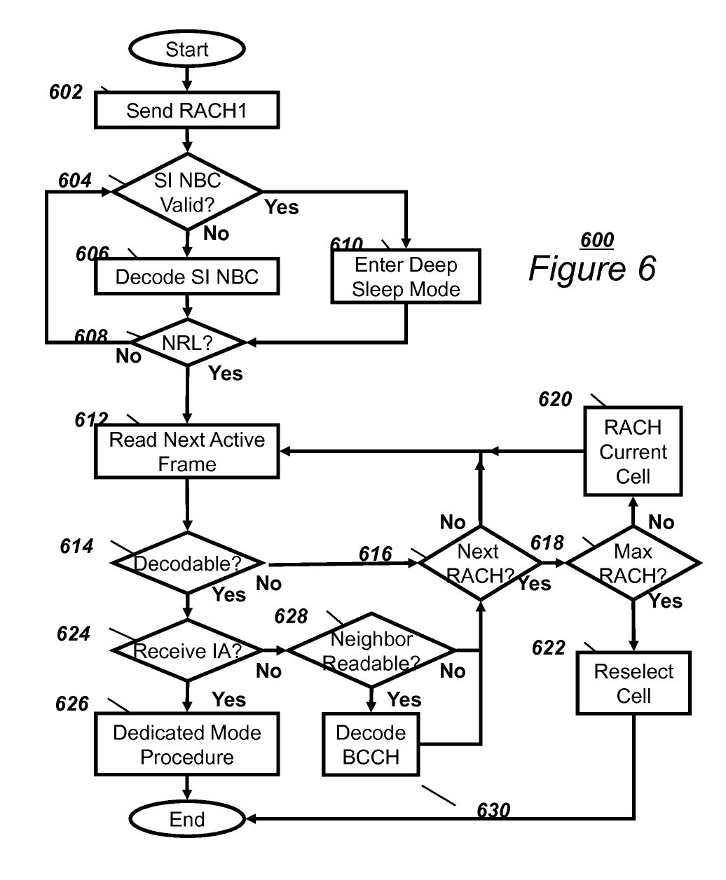

By expediting a cellular call setup time, the MCD 210 may more efficiently switch to attempting a connection with a STC 224 when the connection attempt with a PTC 222 fails. FIG. 6 illustrates in a flowchart one embodiment for a method 600 of executing an expedited call set up. The MCD 210 may send an initial RACH message (RACH1) (Block 602). If the SI for the next best cell (NBC) is not valid (Block 604), the MCD 210 may decode the SI NBC Block 606). If an IA command is not expected due to the network response latency time (Block 608), then the SI NBC may be rechecked Block 606). On average, the MCD 210 has at least 100 ms before an IA command can be received. If the SI NBC is valid (Block 604), the MCD 210 may enter deep sleep mode to prevent current drain (Block 610).

Once the network response latency (NRL) period has passed (Block 608), the MCD 210 may read the next active frame 518 (Block 612). If the next frame is not decodable (Block 614) and the time for the next RACH message has not arrived (Block 616), then the MCD 210 may read the next active frame 518 Block 612). If the time for the next RACH message has arrived Block 616) and the threshold number for the maximum number of RACH attempts to that cell has not been reached (Block 618), then the MCD 210 may send a RACH message to the current cell (Block 620). If the time for the next RACH message has arrived Block 616) and the threshold number for the maximum number of RACH attempts to that cell has been reached Block 618), the MCD 210 may reselect a cell (Block 622). If the next frame is decodable Block 614) and an IA message is received (Block 624), then the MCD 210 may enter a dedicated mode procedure (Block 626). If an IA message is not received (Block 624) and the neighboring cell BCCH is not readable (Block 628), then the MCD 210 may check if the time for the next RACH message has arrived (Block 616). If the neighboring cell BCCH is readable Block 628), then the MCD 210 may decode the neighboring cell BCCH (Block 630) and may check if the time for the next RACH attempt has arrived (Block 616).

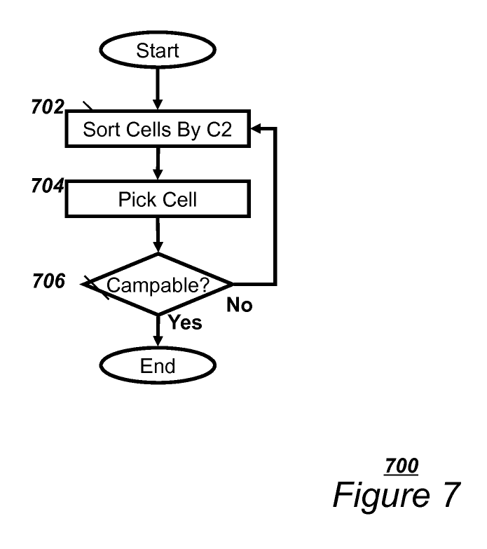

The preemptive decoding of the BCCH of neighboring cells may drastically speed up the cell reselect process and reduce current drain. FIG. 7 illustrates in a flowchart one embodiment of an expedited cell reselect process 700. The MCD 210 may sort the cells under cell reselection criteria (C2) (Block 702). The MCD 210 may pick a cell among the sorted list that has the RACH parameters decoded (Block 704). If the cell is unable to camp on that cell (Block 706), the MCD 210 may resort the list (Block 702). Otherwise, the MCD 210 may camp on the next cell connection parameters or restart the RACH process.

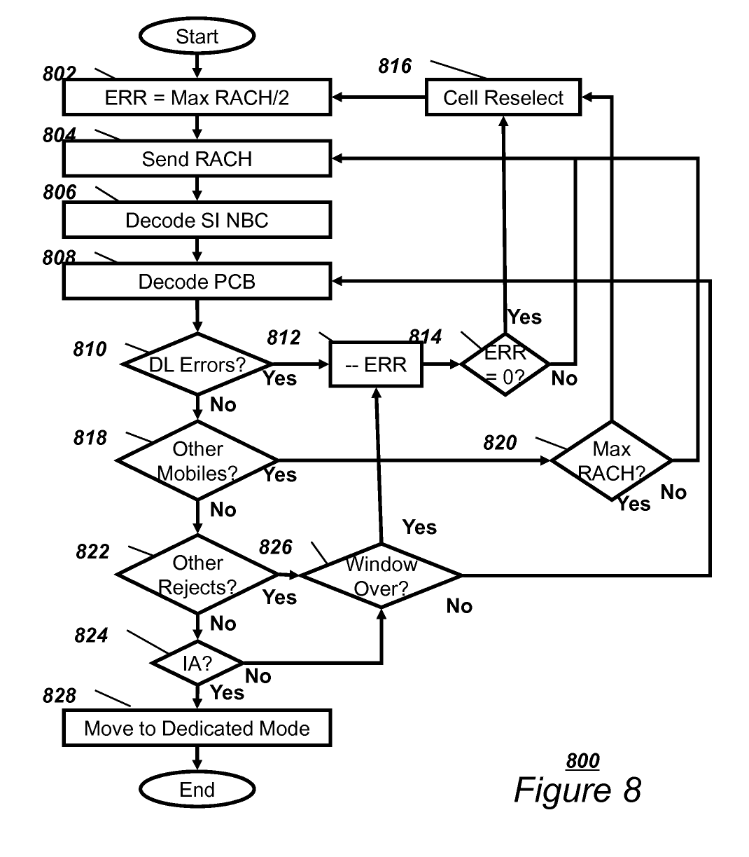

The call set up procedure may be further expedited by adjusting the maximum number of RACH messages that are attempted with any given cell. FIG. 8 illustrates in a flowchart one embodiment of a method 800 of adjusting the access process to reflect channel quality. The MCD 210 may set an error counter (ERR) to equal half the maximum number of RACH retransmissions (Block 802). While half the maximum number of RACH retransmission are used in this embodiment, ERR may be set to any number less than the maximum number of RACH transmissions. The MCD 210 may then send a RACH message (Block 804). The MCD 210 may decode the SI NBC during the network response latency time (Block 806). The MCD 210 may decode a paging channel block (PCB) for an IA message (Block 808).

The MCD 210 may determine if downlink errors have caused a failure to decode IA messages. The MCD 210 may reduce the threshold number of RACH messages as a result. If the MCD 210 detects some downlink errors while decoding (Block 810), the MCD 210 may decrement ERR (Block 812). If ERR is equal to zero (Block 814), the MCD 210 may select a new cell (Block 816). If ERR does not equal zero (Block 814), the MCD 210 may send a new RACH message (Block 804).

The MCD 210 may determine if uplink collisions are interfering with reception by the telecommunication cell of the RACH messages. If the MCD 210 receives an IA message for other mobile devices on the same absolute frame number (AFN) (Block 818), and the maximum number of RACH attempts has been reached (Block 820), then the MCD 210 may select a new cell (Block 816). If the maximum number of RACH attempts has not been reached (Block 820), then the MCD 210 may send a new RACH message (Block 804).

The MCD 210 may determine if the network is busy, as indicated by the MCD 210 receiving an IA rejection message for other mobile devices. The MCD 210 may also detect uplink errors or network errors. If the MCD 210 has received an IA rejection message for other mobile devices (Block 822) or has not received an IA message (Block 824) and the monitoring window is over (Block 826), then the MCD 210 may decrement ERR (Block 812). If the monitoring window is not over (Block 826), the MCD 210 may decode the next paging channel block for an IA message (Block 808). If an IA message has been received (Block 824), then the RACH was successful and the MCD 210 may move to the dedicated mode procedure (Block 828).

Embodiments may also be practiced in distributed computing environments where local and remote processing devices that are linked (either by hardwired links, wireless links, or by a combination thereof) through a communications network may perform tasks.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for establishing a cellular connection, comprising:
selecting a primary telecommunication cell;
decoding a primary connection parameter for the primary telecommunication cell;
executing an initial primary connection attempt with the primary telecommunication cell; and
decoding a secondary connection parameter for a secondary telecommunication cell prior to a subsequent primary connection attempt.

2. The method of claim 1, wherein a primary radio executes the initial primary connection attempt and decodes the secondary connection parameter.

3. The method of claim 1, wherein a primary radio executes the initial primary connection attempt and a secondary radio decodes the secondary connection parameter.

4. The method of claim 1, wherein the initial primary connection attempt is executed using a random access channel and the secondary connection parameter is decoded using a broadcast control channel.

5. The method of claim 1, further comprising:
repeating primary connection attempts with the primary telecommunication cell until a primary connection with the primary telecommunication cell is established or a threshold number of primary connection attempts is reached; and
switching to an initial secondary connection attempt with the secondary telecommunication cell.

6. The method of claim 5, further comprising:
adjusting the threshold number based upon channel quality.

7. The method of claim 1, wherein the secondary connection parameter is decoded during a network latency response period.

8. The method of claim 1, wherein the secondary connection parameter is decoded during available time division multiple access frames.

9. The method of claim 1, further comprising:
entering a sleep mode until the subsequent primary connection attempt after the secondary connection parameter is successfully decoded.

10. A telecommunications apparatus for establishing a cellular connection, comprising:
a processor that selects a primary telecommunication cell;
a primary radio that decodes a primary connection parameter for the primary telecommunication cell, executes an initial primary connection attempt with the primary telecommunication cell, and decodes a secondary connection parameter for a secondary telecommunication cell prior to a subsequent primary connection attempt.

11. The telecommunications apparatus of claim 10, wherein the initial primary connection attempt is executed using a random access channel and the secondary connection parameter is decoded using a broadcast control channel.

12. The telecommunications apparatus of claim 10, wherein the first radio repeats primary connection attempts with the primary telecommunication cell until a primary connection with the primary telecommunication cell is established or a threshold number of primary connection attempts is reached and switches to an initial secondary connection attempt with the secondary telecommunication cell.

13. The telecommunications apparatus of claim 12, wherein the processor adjusts the threshold number based upon channel quality.

14. The telecommunications apparatus of claim 10, wherein the secondary connection parameter is decoded during a network latency response period.

15. The telecommunications apparatus of claim 10, wherein the secondary connection parameter is decoded during available time division multiple access frames.

16. The telecommunications apparatus of claim 10, wherein the processor enters a sleep mode until the subsequent primary connection attempt after the secondary connection parameter is successfully decoded.

17. An electronic device for establishing a cellular connection, comprising:
a processor that selects a primary telecommunication cell;
a primary radio that decodes a primary connection parameter for the primary telecommunication cell and executes an initial primary connection attempt with the primary telecommunication cell; and
a secondary radio that decodes a secondary connection parameter for a secondary telecommunication cell prior to a subsequent primary connection attempt.

18. The electronic device of claim 17, wherein the first radio repeats primary connection attempts with the primary telecommunication cell until a primary connection with the primary telecommunication cell is established or a threshold number of primary connection attempts is reached and switches to an initial secondary connection attempt with the secondary telecommunication cell.

19. The electronic device of claim 18, wherein the processor adjusts the threshold number based upon channel quality.

20. The electronic device of claim 17, wherein the processor enters a sleep mode until the subsequent primary connection attempt after the secondary connection parameter is successfully decoded.
